(19) United States
(12) Patent Application Publication
(10) Pub. No.: US 2012/0008892 A1
(43) Pub. Date: Jan. 12, 2012

(54) ANTIFRICTION BEARING FOR MOUNTING THE ROTOR OF A WIND POWER PLANT

(75) Inventor: Martin GREHN, Dittelbrunn (DE)

(73) Assignee: SCHAEFFLER TECHNOLOGIES GMBH & CO. KG, Herzogenaurach (DE)

(21) Appl. No.: 13/179,060

(22) Filed: Jul. 8, 2011

(30) Foreign Application Priority Data
Jul. 9, 2010 (DE) 10 2010 026 649.3

(51) Int. Cl. F16C 33/58

(52) U.S. Cl. 384/569

(57) ABSTRACT

An antifriction bearing for mounting a rotor of a wind power plant, which is easy to mount and has satisfactory functional properties. The antifriction bearing has an outer ring, an inner ring and having a plurality of rolling bodies which are arranged between the inner ring and the outer ring. The outer ring has at least two segments in a circulation direction. One of the segments is a high load segment that extends over a region in the circulation direction greater than 180°, preferably greater than 200° and, in particular, greater than 250°, and/or the separating gaps between the segments are arranged in a region in the circulation direction of less than 180°, preferably less than 160° and, in particular, less than 110°.

This application claims the priority of DE 10 2010 026 649.3 filed Jul. 9, 2010, which is incorporated by reference herein.

### FIELD OF THE INVENTION

The invention relates to a bearing for mounting the rotor of a wind power plant having an outer ring, having an inner ring and having a plurality of rolling bodies which are arranged so as to roll between the inner ring and the outer ring, the outer ring having at least two segments in the circulation direction. The invention also relates to a wind power plant having said antifriction bearing.

### BACKGROUND OF THE INVENTION

Antifriction bearings for wind power plants, in particular for mounting the rotor, have to be of very large dimensions in accordance with the requirements and often have pitch circle diameters of several meters. It is obvious that the mounting and if necessary the replacement of antifriction bearings of this type is very difficult, since the rings of said antifriction bearings have to be pulled off over the rotor shafts without further measures or the rotor shaft has to be dismantled. Since the wind power plants are tower-like structures and antifriction bearings of this type are used in the tower top region, the mounting or the replacement of an antifriction bearing of this type is associated with great outlay as a result.

Application series DE 20 306 890 U1 DE 20 306 897 U1, DE 20 306 899 U1 relates to an antifriction bearing having at least one segmented bearing ring and certainly forms the closest prior art. Said documents propose an antifriction bearing having at least one bearing ring which is composed of a plurality of segments which are placed next to one another at their end faces in the circumferential direction, and having rolling bodies which roll on the bearing ring. The field of application of segmented bearing rings of this type is seen, for example, in wind power plants, it being possible for the bearing rings to typically have a diameter of a few meters. Antifriction bearings having segmented bearing rings are frequently also used when extensive dismantling work would be required to replace a bearing ring which is configured in one piece.

### BACKGROUND OF THE INVENTION

The invention is based on the object of proposing an antifriction bearing for mounting the rotor of a wind power plant, which antifriction bearing is easy to mount and at the same time has satisfactory functional properties.

This object is achieved by an antifriction bearing having an outer ring, an inner ring and a plurality of rolling bodies which roll between the inner ring and the outer ring, with the outer ring having at least two segments in a circulation direction. Separation gaps are present between the at least two segments, and one of the at least two segments is a high load segment that extends over a region in the circulation direction of greater than 180°, preferably greater than 200° and, in particular, greater than 250°, and/or in that all separating gaps between the segments are arranged in a region in the circulation direction of less than 180°, preferably less than 160° and, in particular, less than 110°. Also, the object is achieved by a wind power plant comprising an antifriction bearing for mounting the rotor of a wind power plant, having an outer ring, an inner ring and a plurality of rolling bodies which roll between the inner ring and the outer ring, with the outer ring having at least two segments in a circulation direction. Separation gaps are present between the at least two segments, and one of the at least two segments is a high load segment that extends over a region in the circulation direction of greater than 180°, preferably greater than 200° and, in particular, greater than 250°, and/or in that all separating gaps between the segments are arranged in a region in the circulation direction of less than 180°, preferably less than 160° and, in particular, less than 110°. The antifriction bearing is arranged in a standing and/or upright manner, and in that the high load segment is arranged in a high load radial zone and/or on a bottom side. Preferred or advantageous embodiments of the invention result from the subclaims, the following description and the appended figures.

It serves, in particular, to mount the rotor or the rotor shaft and/or parts of a torque-transmitting gear mechanism between the rotor and generator of a wind power plant. The antifriction bearing can be configured, in particular, as a locating bearing, floating bearing or as a torque hearing. In the configuration as a torque bearing, the antifriction bearing is capable of absorbing both axial and radial loadings and/or torques and of conducting them away into a surrounding construction.

The antifriction bearing comprises an outer ring, an inner ring and a plurality of rolling bodies, in particular rollers, which are arranged so as to roll between the inner ring and the outer ring, with the result that the inner ring and the outer ring can rotate or pivot relative to one another about a rotational axis. The outer ring and inner ring can also have further regions, such as connecting regions for mounting or parts of the surrounding construction, etc.

The outer ring is divided in the circulation direction into at least two segments, that is to say a raceway or all the raceways of the outer ring is/are divided in the circulation direction into the at least two segments. The two segments are preferably configured in such a way that they abut one another on the end side in the circulation direction. In possible embodiments of the invention, the separating gaps between the two segments are arranged so as to extend obliquely with respect to the circulation direction, said separating gaps being pivoted at least by 10° with respect to a purely axially oriented profile. This configuration has the advantage that the loading at the separating points is reduced in comparison with purely axially extending separating points.

According to the invention, a high load segment of the at least two segments extends over a region in the circulation direction and/or as a circular arc of greater than 180°, preferably greater than 200° and, overall, greater than 250°. As an alternative or in addition, all separating gaps between the segments which form the outer ring are in a region in the circulation direction and/or in a circular arc of less than 180°, preferably less than 160° and, in particular, less than 110°. Here, the degree specifications relate in the circulation direction about the rotational axis of the antifriction bearing in a radial plane which is perpendicular with respect to the rotational axis. In particular, the outer ring is divided asymmetrically and/or non-equally into segments. It is also possible, in particular, that the outer ring is optionally in addition divided in the axial direction.

The invention is based on the consideration that divided bearing rings can also be installed in difficult installation situations, without it being necessary to dismantle surrounding constructions or the shafts to be mounted. For example, it is possible in the case of the wind power plant to position the antifriction bearing as a rotor bearing in a separated configuration on site on a tower of the wind power plant and without dismantling of the turbine house or the shaft of the wind power plant. The disadvantage of single-piece rotor mountings is therefore avoided, which disadvantage consists of it usually being necessary to disassemble the entire wind turbine.

It is a further consideration of the invention that the separating points, also called separating gaps, between the segments of the bearing ring form weak points which can reduce the service life of the bearing ring. In the context of the invention, it is proposed either to arrange all the separating gaps between the segments in an angular region of less than 180° or to use a high load segment which extends over a region of greater than 180°. More than half the circumference of the antifriction bearing is therefore formed from a single-piece bearing ring, in particular from a continuous raceway. The particular advantage of the invention lies in the fact that, precisely in the case of antifriction bearings for rotor mountings, which antifriction bearings are installed in a standing manner, the load zone is situated in the lower half of the bearing ring on account of gravity forces. In addition, it is taken into consideration that, although a circumferential angle of 180° would be sufficient for the high load segment in the case of pure radial loads and an optimum installation position of the antifriction bearing, in order to cover the load zone with a single-piece hearing ring region, it has been proven that, in the case of the occurrence of axial loadings and/or axial torques, the load zone in a rolling body row expands quickly over the circumferential angles customary for radial loads and can extend over a circumference of more than 180°. It is advantageous for this reason to arrange the separating points between the segments in a region of less than 180° or to use a high load segment with a circumferential angle of greater than 180°, with the result that the load zone can be arranged exclusively or substantially in the high load segment.

The remaining circumferential angle or circular arc residual which is not covered by the high load segment is preferably selected in such a way that the narrowest circle chord or the smallest opening region is sufficient for it to be possible for the high load segment to be inserted over a shaft, in particular the rotor shaft. In one possible development of the invention, the smallest opening region and/or the circumferential angle or circular arc residual are/is selected in such a way that the high load segment can be inserted over the shaft with the inner ring already placed on it. The free part of the high load segment is closed by at least one further segment.

In one particularly preferred embodiment of the invention, the outer ring is divided into exactly two segments with regard to the circulation direction. As a result of the use of the exactly two segments, the number of separating points per raceway is minimized to exactly two separating points, with the result that the advantages of the invention can be exploited in an optimum manner and at the same time disadvantages on account of separating points on the raceway are minimized.

There is provision in one preferred development of the invention for the inner ring to comprise at least two segments in the circulation direction. Particularly preferably, the inner ring is divided in half, with the result that each of the at least two segments covers a 180° angle. However, the inner ring can also be of multiple-piece configuration.

In order to ensure sufficient stability of the inner ring and/or the outer ring, it is preferred to connect the respective segments to one another fixedly, but releasably in order to afford a repair option. Particularly preferably, the segments of the inner ring and of the outer ring arc connected to one another during installation, for example are screwed to one another.

In one possible embodiment of the invention and as a consistent development, the antifriction bearing has a segment cage which is constructed from a plurality of cage segments in the circulation direction. Particularly preferably, at least one cage segment, preferably some cage segments and, in particular, all cage segments are coupled releasably in the segment cage, in order to facilitate mounting and dismantling. Particularly preferably, the circumferential length of at least one cage segment, some or all cage segments are dimensioned in the maximum extent in such a way that it or they can be inserted or removed in the radial direction through the opening region of the high load segment.

In order to facilitate the mounting of the segment cage, the rolling bodies are preferably arranged in the cage segments in a self-locking manner, for example are held in a positively locking manner, with the result that said cage segments form a unit ready for mounting. This optional development also facilitates the mounting and dismantling of the antifriction bearing in difficult installation situations.

In one preferred structural embodiment of the invention, the antifriction bearing is realized as a single-row or multiple-row self-aligning roller bearing. In alternative embodiments, the antifriction bearing can also be configured as a tapered roller bearing or cylindrical roller bearing.

A further subject matter of the invention relates to a wind power plant having an antifriction bearing according to one of the preceding claims, in particular for mounting the rotor shaft, specifically configured as a locating hearing for mounting the rotor shaft. The antifriction bearing is arranged such that it is oriented in a standing manner, that is to say perpendicular with respect to a horizontal or in an angular region between +/−45°, preferably between +/−30° and, in particular, between +/−15° with respect to the perpendicular or with respect to a vertical, such that a high load radial zone results in the support of the rotor shaft on account of gravity. The high load segment is arranged in said high load radial zone and/or is positioned on the bottom side.

This configuration is based on the consideration that, in the case of a standing antifriction bearing, the radial loads are supported significantly over circulation angle regions which are arranged in angular terms between 3 o'clock (90°) and 9 o'clock (270°) in a clock representation. The high load segment is then positioned precisely in this region, with the result that the separating gaps are arranged outside the high load radial zone.

In one preferred development of the invention, the opening region of the high load segment is configured to be greater than the diameter of the rotor shaft, with the result that the rotor shaft can be inserted through the opening region during mounting.

### BRIEF DESCRIPTION OF THE DRAWINGS

Further features, advantages and effects of the invention result from the following description of preferred exemplary embodiments of the invention and the appended figures, in which:

FIG. 1 shows a cross section through the rotational axis of an antifriction bearing as one exemplary embodiment of the invention;

FIG. 2 shows a part of a segmented cage of the invention;

FIG. 3 shows a cross-sectional view of a multiple-row self-aligning roller bearing; and

FIG. 4 shows a single-row self-aligning roller bearing.

### DETAILED DESCRIPTION OF THE DRAWING

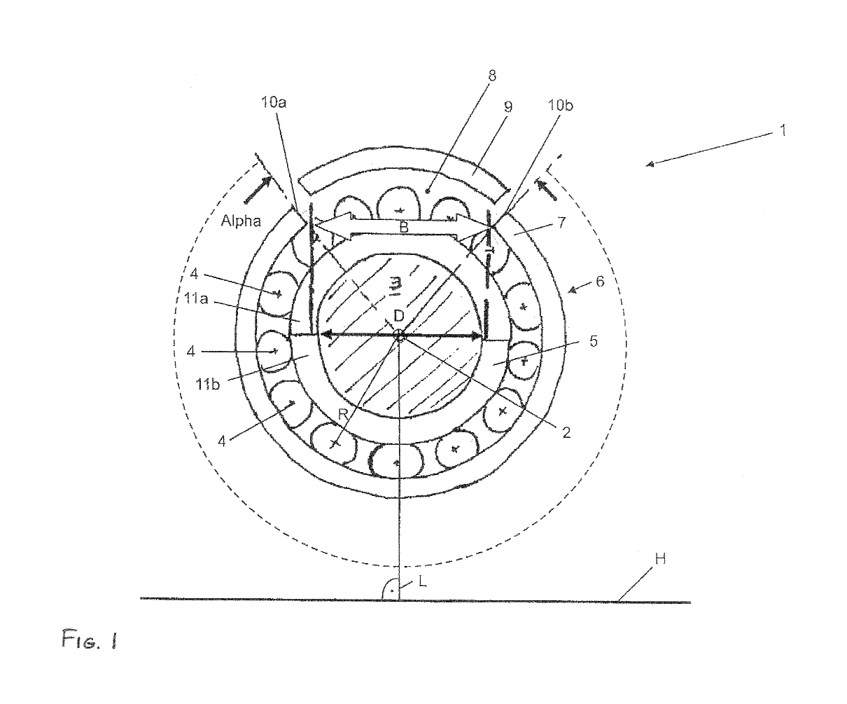

FIG. 1 shows an antifriction bearing 1 in a diagrammatic cross section through its rotational axis 2. The antifriction bearing 1 is configured as a large antifriction bearing with a pitch circle radius r of greater than 500 mm, preferably greater than 750 mm and, in particular, greater than 1000 mm. In the installed state, the antifriction bearing serves to mount a rotor shaft 3 of a wind power plant, which rotor shaft 3 connects the rotor, optionally via a gear mechanism, to a generator in a turbine house of the wind power plant. The installation position of the antifriction bearing 1 is standing or upright. The antifriction bearing 1 is configured here as a roller bearing and, in a practical use, can be equipped, in particular, as a self-aligning roller bearing with one or two rows of rolling bodies 4.

The antifriction bearing 1 has an inner ring 5 and an outer ring 6 which are arranged concentrically and/or coaxially with respect to the rotational axis 2 and between which the rolling bodies 4 roll during operation.

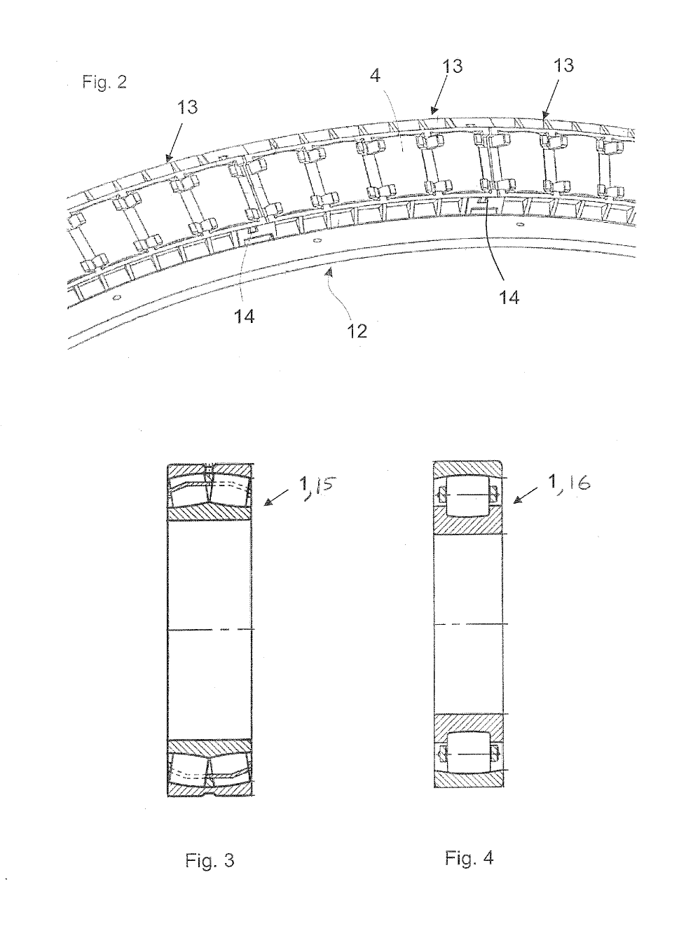

In one exemplary embodiment as shown in FIG. 2, the rolling bodies 4 are held in a segment cage 12 which is divided in the circulation direction into a plurality of cage segments 13 which are preferably connected to one another in an articulated manner by frontal connections 14. Here, the dimensioning of the cage segments 13 is selected in such a way that they can likewise be installed and dismantled through the smallest opening region b of the high load segment 7 in a radial direction. In order to simplify the mounting, the cage segments 13 can be configured in such a way that the rolling bodies 4 are arranged in them in a self-locking manner.

The high load segment 7 and the segment 9 abut one another on the end side at the separating points 10a, 10b and are connected fixedly to one another there; for example, they can be screwed to one another.

The circumferential angle of the segment 9 or the opening region 8 of the high load segment 7 is selected here in such a way that the resulting opening of the high load segment 7 has a minimum opening width b which is configured to be greater than the diameter D of the rotor shaft 3.

The inner ring 5 is likewise constructed from two segments 11a, 11b which in each case cover a circumferential angle of 180°. The connection of the two segments 11a, b can likewise take place via screwing.

In some exemplary embodiments, the rolling bodies 4 are held in a segment cage which is divided in the circulation direction into a plurality of cage segments (not shown) which are preferably connected to one another in an articulated manner. Here, the dimensioning of the cage segments is selected in such a way that they can likewise be installed and dismantled through the smallest opening region b of the high load segment 7 in a radial direction. In order to simplify the mounting, the cage segments can be configured in such a way that the rolling bodies 4 are arranged in them in a self-locking manner.

The illustration which is shown in FIG. 1 corresponds to one possible installation position in the wind power plant, the antifriction hearing 1 being arranged in a standing manner with respect to a horizontal H. The high load segment 7 is arranged symmetrically with respect to a perpendicular L and is open to the top.

A first advantage of the antifriction bearing 1 results from the fact that the outer ring 6 can be pushed over the rotor shaft 3 in the radial direction and therefore complete dismantling of the rotor shaft 3 and/or the surrounding construction is not necessarily required. As a result of the fact that the inner ring 5 is likewise of at least two-piece configuration, said inner ring 5 can likewise be mounted and dismantled without dismantling the rotor shaft.

A further advantage results from the fact that the weak points of the outer ring 6 in the circumferential direction, namely the separating points 10a, b, are arranged outside the load zone of the antifriction bearing 1, with the result that they do not reduce the service life of the outer ring 6, or do not reduce it considerably, and the antifriction bearing 1 according to the invention has a similar expected service life as an antifriction bearing with a single-piece outer ring. During operation, the radial load zone is arranged on the bottom side and results significantly from the fact that the heavy rotor shaft 3 with connected components is supported against gravity via the antifriction bearing 1. However, in the case of higher axial load components, the load zone also expands over a circumference of more than 180°. The high load segment 7 as larger outer ring segment is dimensioned by the circular arc circumference of approximately 260° in such a way that it can absorb the roller loads without loading of the separating gaps 10a, b occurring.

FIG. 3 shows a multiple-row self-aligning roller bearing 15 and FIG. 4 shows a single-row self-aligning roller bearing 16.

### LIST OF DESIGNATIONS

1 Antifriction Bearing
2 Rotational Axis
3 Rotor Shaft
4 Rolling Bodies
5 Inner Ring
6 Outer Ring
7 High Load Segment
8 Opening
9 Segment
10a, 10b Separating Points
11a, 11b Segments
12 Segmented Cage
13 Cage
14 Frontal Connections
15 Multiple-Row Self-Aligning Roller Bearing
16 Single-Row Self-Aligning Roller Bearing

1. An antifriction bearing for mounting on a rotor of a wind power plant, comprising:
an outer ring;
an inner ring; and
a plurality of rolling bodies arranged to roll between the inner ring and the outer ring,
the outer ring is segmented into at least two separate, circumferential segments, one of the at least two circumferential segments being a high load segment that extends over a region in a circumferential direction of greater than 180°.

2. The antifriction bearing according to claim 1, wherein the high load segment extends over the region in the circumferential direction of greater than 200°.

3. The antifriction bearing according to claim 1, wherein the high load segment extends over the region in the circumferential direction of greater than 250°.

4. The antifriction bearing according to claim 1, wherein the outer ring is divided into two segments.

5. The antifriction bearing according to claim 1, wherein the inner ring has at least two segments in the circumferential direction.

6. The antifriction bearing according to claim 5, wherein the segments of the inner ring and/or the segments of the outer ring are screwed to one another.

7. The antifriction bearing according to claim 1, further comprising a segment cage which is constructed from a plurality of cage segments, at least one, some or all cage segments being configured in such a way that the segments can be removed in a radial direction through an opening region of one of the segments of the outer ring which is a high load segment.

8. The antifriction bearing according to claim 7, wherein the rolling bodies are arranged in the segment cage in a self-locking manner.

9. The antifriction bearing according to claim 1, wherein the antifriction bearing is a single-row or a multiple-row self-aligning roller bearing.

10. A wind power plant, comprising:
an antifriction bearing for mounting the rotor of a wind power plant, having an outer ring; an inner ring; and a plurality of rolling bodies which are arranged so as to roll between the inner ring and the outer ring, the outer ring having at least two segments in a circumferential direction, the at least two segments having separation gaps between the at least two segments, one of the at least two segments being a high load segment that extends over a region in the circumferential direction of greater than 180° and/or in that the separating gaps between the segments are arranged in a region in the circumferential direction of less than 180°,
wherein the antifriction bearing is arranged in a standing and/or upright manner, and in that the high load segment is arranged in a high load radial zone and/or on a bottom side of the outer ring.

11. The wind power plant according to claim 10, wherein the rotor has a shaft with a diameter and the high load segment has an opening region that is greater than the diameter of the rotor shaft.
